(19) United States
(12) Patent Application Publication
(10) Pub. No.: US 2012/0034493 A1
(43) Pub. Date: Feb. 9, 2012

(54) ELECTRODE DEVICE, GENERATOR DEVICE AND METHOD FOR POWER GENERATION BY MEANS OF MEMBRANE-POTENTIAL SHUNTING

(75) Inventors: Joachim Spatz, Stuttgart (DE); Amin Rustom, Weinheim (DE)

(73) Assignee: Max-Planck-Gesellschaft zur Foerderung der Wissenschaften e.V., Muenchen (DE)

(21) Appl. No.: 13/062,578

(22) PCT Filed: Sep. 7, 2009
(86) PCT No.: PCT/EP2009/006469

§ 371 Date: Apr. 14, 2011

(30) Foreign Application Priority Data
Sep. 16, 2008 (DE) 10 2008 047 399.5

(51) Int. Cl. H01M 8/16; H01M 4/64; H01M 2/10

(52) U.S. Cl. 429/2

(57) ABSTRACT

An electrode device (100) set up for membrane-potential shunting to cells (1) with membrane casings (2) comprises a cell holder (10) designed to hold the cells, and an electrode support (20) having at least two electrodes (21) of a first polarity, wherein the electrodes (21) are designed as protrusions which extend over one surface of the electrode support (20) and are electrically insulated relative to the surface of the electrode support (20), and wherein the electrodes (21) are arranged so that when the cell holder (10) is populated with cells (1), the electrodes (21) are positioned in the cells (1). A generator device (200) designed to generate electric power through membrane-potential shunting to cells (1) with a membrane casing (2) is described, and a method to generate electric power by shunting of a membrane potential to the cells (1).

The invention relates to an electrode device which is adapted for deriving a membrane potential on at least one membrane-enclosed cell, particularly on a multiplicity of cells. Furthermore, the invention relates to a generator device which is provided with the electrode device and is adapted for electricity generation by deriving a membrane potential. Finally, the invention also relates to a method for electricity generation by deriving a membrane potential at at least one biological or synthetic cell. Applications of the invention exist, in the case of the generation of electric current, for the operation of an electrical device and/or for the charging of a rechargeable battery.

The supply of electrical energy constitutes one of the biggest challenges of current technical development. In the case of the development of electricity generators, the replacement of conventional energy conversion from fossil fuels by means of sustainable, renewable energy sources is of particular interest. In addition to energy sources based on for example hydroelectric or wind power, solar power or geothermal energy, energy sources based on biological materials count among renewable energy sources.

The main concept for energy conversion using biological materials is based on the generation and combustion of biogas (principally methane) or of hydrogen (see J Niessen et al. in “Letters in Applied Microbiology”, Volume 41, 2005, pp. 286-290). Energy conversion from biogas is disadvantageous due to the carbon dioxide generated during the combustion and due to the production of by-products, such as for example ammonia and hydrogen sulphide, which necessitate expensive cleaning steps. Further concepts are based on so-called bio-fuel cells which are operated on the basis of an enzymatic decomposition of macromolecules, such as for example sugar (see R. F. Service in “Science”, Volume 296, 2002, p. 1223). These concepts also have not found routine application, as the energy yield, the limited stability of the energy conversion and the high costs have proven disadvantageous.

It is generally known from cell biology that eukaryotic biological cells form a membrane potential across the cell membrane. Cell membranes contain membrane parts which are laid out for ion transport. These membrane parts, which comprise ion pumps and ion channels, are designated succinctly as ion pumps in the following. An electrochemical gradient, which forms the membrane potential, is generated by the ion transport across the cell membrane. The membrane potential can be measured with electrophysiological methods (see for example E. Neher in “Science”, Volume 256, 1992, pp. 498-502; W. Baumgartner et al. in “Biophysical Journal”, Volume 77, 1999, pp. 1980-1991; DE 101 08 968 A1; or DE 198 27 957 A1).

The conventional electrophysiological measurement of the membrane potential is illustrated schematically in FIG. 8. A biological cell 1′ is held in a cultivation medium 3′ using a pipette 10′. An anode 22′ is dipped into the cultivation medium 3′ and a cathode 21′ projects from the cultivation medium 3′ into the interior of the cell 1′ in an insulated manner. The anode 22′ and the cathode 21′ are connected to an amplifier 30′, using which electrical signals, which represent the membrane potential derived, are amplified and prepared for further processing. The pipette 10′ forms a cell holder which, as is known for example in practice for measurement at adherent cells, can be replaced by a substrate in the cultivation medium 3′, on which the cell 1′ is arranged.

The application of the conventional measurement device according to FIG. 8 is limited to the measurement of the membrane potential at individual cells. As glass electrodes or metal-filled glass capillaries with tip diameters above 100 nm have hitherto been used as cathode 21′, problems result due to a low tolerance of the cell 1′ with respect to the cathode 21′ and a limitation to high measuring resistances. So, electrodes with diameters above 10 pm can only be tolerated for a few hours by the cell, for example. The measuring resistance is of the order of magnitude of 100 MΩ, as a result of which the currents derived are limited to minimum charges.

An electrophysiological measurement of membrane potential with a plurality of electrodes is described in DE 10 2005 030 859 A1. An insulating plate is used as support for one or a plurality of cells. Electrodes with electrically conductive surfaces project through the plate into the at least one cell. It is disadvantageous that a high electrical seal resistance must be realized by the mechanical contact between the at least one cell and the plate. As a result, high minimum spacings of the electrodes and limited signal amplitudes result.

It is the objective of the invention to provide an improved electrode device which is suitable for deriving membrane potential at membrane-enclosed cells and using which, the disadvantages of conventional technologies can be overcome. It is furthermore the objective of the invention to provide an improved generator device for generating electric current using biological materials, using which limitations of conventional generator devices are overcome and which stand out in particular by an increased service life, improved operational stability and reduced costs. It is also the objective of the invention to provide an improved method for energy conversion using biological materials, particularly for electricity generation, using which disadvantages of conventional renewable energy sources based on biological materials can be avoided.

These objectives are achieved by means of an electrode device, a generator device and by means of a method with the features of the independent claims, respectively. Advantageous embodiments and applications of the invention result from the dependent claims.

According to a first aspect of the invention, the above objective is achieved by means of an electrode device which is adapted for deriving membrane potential at membrane-enclosed cells and has a cell holder for adherent fixing of the cells and an electrode carrier with at least two electrodes of a first polarity, which are formed as projections above a surface of the electrode carrier and are electrically insulated relative to the surface of the electrode carrier. According to the invention, the electrode carrier is formed in such a manner that when the cell holder is carrying the cells, the electrodes simultaneously project into the cells.

According to a second aspect of the invention, the objective is achieved by means of a generator device which is adapted for generating electric current by means of the deriving (conducting away) of a membrane potential at cells and has an electrode device according to the above-mentioned first aspect, at least one cell, preferably, however, a multiplicity of cells, being arranged on the surface of the cell holder.

According to a third aspect, the objective is achieved by means of a method for the generation of electric current by means of the deriving of a membrane potential on cells which are arranged in an adherent state on the cell holder of the electrode device in accordance with the above-mentioned first aspect, the electric current being derived with the electrodes and at least one counter electrode, which is in direct electrical contact with the cells or is in indirect electrical contact e.g. via a conductive medium.

Advantageously, an electrode arrangement which has an increased stability of the electrodes and an improved construction compared to conventional technologies is realized by means of the electrode carrier with the at least two electrodes. The formation of the electrodes with a reduced electrode diameter compared to conventional technologies is enabled in particular, as a result of which the tolerance of the cell with respect to the electrode is improved and the measuring resistance is reduced.

Before the invention it was not known to use the deriving of potential for electricity generation. As it was known that the deriving of the membrane potential only results in an electric current of up to 100 μA at 200 mV, even in the case of cells with strong ion transport, such as for example Xenopus egg cells (see above publication by W. Baumgartner et al.), utilization of the membrane potential for energy conversion, particularly for electricity generation was not considered before the invention. On the contrary, it was even additionally necessary to equip measuring systems with amplifiers, without which an electrophysiological measurement of the extremely small currents and voltages would not be possible. This preconception is overcome with the invention. The electrode carrier with a plurality of electrodes makes it possible for the electrodes to be brought into direct electrical contact with the interior of at least one, preferably however a multiplicity of cells, simultaneously and particularly such that they are electrically connected in parallel. The inventors have recognized that by means of the use of the electrode carrier, the deriving of membrane potential is scalable and thus the limitation to impractically small currents can be overcome. Furthermore, it is possible to set the current intensity and/or the voltage of the generator device in dependence on the conditions of the actual application by means of a parallel circuit, a series circuit or a combination of parallel and series circuits.

The invention has the following further advantages. The generator device according to the invention constitutes a renewable source of electricity which is suitable as a macroscopic current supply in load circuits. The contacting of the cells takes place by means of self integration of the cells at the electrodes of the electrode device. The electrode carrier has a nano- or microstructured surface due to the electrode projections. Due to the structure, the binding of the cells to the projections and thus the accommodation of the electrodes into the cells and their contacting is enhanced. Further advantages of the invention consist in the environmental compatibility of the generator device and the sustainability and also climate neutrality of the electricity generation.

In dependence on the application of the invention, it may also be sufficient, however, that only a single electrode is provided on the electrode carrier and/or the membrane potential is derived from a single cell. These variants thus likewise belong to the subject of the present invention.

The term “cell” (or: cell element, compartment) generally relates to a liquid region enclosed by a membrane, the membrane being adapted for generating the membrane potential between the liquid region in the interior of the cell and a liquid, for example a cultivation medium in the surroundings of the cell. The membrane contains proteins which form ion pumps (and ion channels) and are adapted for ion transport between the external surroundings of the cell and the interior of the cell.

The generator device according to the invention is thus based on the use of biological materials in that the electrochemical membrane potential of cultivated biological cells, which naturally contain ion pumps, or of synthetic lipid vesicles (“phantom cells”) which contain ion pumps integrated into the membrane, which establish the potential between the interior and the external surroundings of the vesicles, is used for electricity generation.

Biological cells have the advantage that the capacity for forming a membrane potential exists naturally due to the ion pumps present. Eukaryotic cells or prokaryotic cells, such as e.g. bacteria, can be used as biological cells, wherein eukaryotic cells being preferred on account of their larger dimension. The ion pumps in the membrane of the vesicles are provided using biotechnological methods which are known per se, preferably using genetically modified biological cells. The lifetime of the cells can be increased by means of the use of immortalized cells in which proteins are newly formed continuously, their folding being monitored and adapted to variable conditions.

Synthetic cells have the advantage that the lifetime of the cells can be increased compared to living biological cells and less strict requirements are placed on the environmental conditions than is the case for the cultivation conditions of biological cells.

According to a preferred embodiment of the invention, the electrodes are formed as projections which are electrically insulated relative to the surface of the cell holder. Particularly preferably, each of the electrodes has an insulating sheath which encloses the electrode with the exception of its free end. The insulating sheath extends in the longitudinal direction of the electrode and leaves the tip of the electrode free.

According to a preferred embodiment of the invention, at least one counter electrode of a second polarity, which is opposed relative to the electrodes mentioned, is provided, the at least one counter electrode being formed on the surface of the electrode carrier and/or on a counter electrode carrier separated from the electrode carrier. The provision of the at least one counter electrode in a predetermined position relative to the electrodes advantageously enables an optimization of the mutual geometric alignment of the electrodes and the at least one counter electrode for achieving a current flow which is derived evenly over the cells.

The at least one counter electrode can comprise a uniform electrically conductive layer or a multiplicity of electrically conductive electrode layer segments on the electrode carrier and/or the counter electrode carrier. The uniform electrically conductive layer has the advantage that the electrical contact with a multiplicity of cells, for example with a cell monolayer on the surface of the electrode carrier can be produced with a single counter electrode. The electrically conductive electrode layer segments can be configured in such a manner that they are controllable, e.g. are connected individually to a load circuit. The individually controllable electrode layer segments have advantages when a non-closed layer of the cells is provided on the surface of the holder device. Furthermore, the electrode layer segments can have advantages for the prevention of short circuits between the electrode layer segments and the electrodes of opposing polarity. Alternatively or additionally, the counter electrode can comprise an electrode rod which is dipped into an ion-containing medium in the surroundings of the cells.

Particularly preferably, at least one of the electrode carrier and the counter electrode carrier constitutes the cell holder. According to the invention, the cells whose membrane potential is derived can be adherently fixed directly on the electrode carrier and/or the counter electrode carrier.

A negative or a positive potential can form in the interior of the cell relative to the external surroundings of the cell, depending on the nature of the transported ions. The electrodes, which project into the interior of the cells and which have at least one counter electrode which is in direct or indirect electrical contact with the exterior of the cell, generally have opposed polarities relative to one another. For a negative potential in the interior relative to the external surroundings, the electrodes form cathodes, whilst the at least one counter electrode forms at least one anode. With a reversed potential, the electrode forms a cathode, whilst the counter electrode forms an anode.

According to a particularly preferred embodiment of the invention, the electrode carrier has a multiple-layer construction with an electrode layer, an insulating layer and a counter electrode layer, the electrodes projecting in an electrically insulated manner from the electrode layer through the insulating layer and the counter electrode layer above the surface of the counter electrode layer. Advantageously, a particularly compact structure of the electrode carrier with all electrodes and counter electrodes is thus created.

Advantageously, the contact between the electrodes and the at least one counter electrode on the one hand and the cells on the other hand can be improved if at least one of the electrodes and/or counter electrodes carries a coating which amplifies the interaction between the electrode surface and the cell membrane. Advantageously, the conductivity can be increased and the contact resistance can be reduced between the cells and the electrodes and/or counter electrodes due to the coating. Preferably, the electrodes projecting on the surface of the electrode carrier carry a coating which activates an endocytosis of the membrane. The endocytosis-activating coating has the advantage that the accommodation of the electrodes into the interior of the cells is facilitated. For example, the endocytosis-activating coating causes biological cells to actively accommodate the electrodes on account of their natural cell movement, so that the electrodes form the contact in the interior of the cells. Alternatively or additionally, the at least one counter electrode can carry an adhesion-promoting and/or conductivity-increasing coating. Advantageously, the adherent binding of the cell to the surface of the electrode or counter electrode carrier is therefore strengthened. Furthermore, a closure of holes which may arise in a layer with a multiplicity of cells is stimulated.

The use according to the invention of the membrane potential for electricity generation can be facilitated if the electrodes which project into the interior of the cells have a smaller diameter than is the case for conventional electrophysiological measurements. Preferably, the diameter of the electrodes is smaller than 10 μm, particularly preferably smaller than 1 μm, such as for example less than 500 nm, particularly less than 100 nm, such as for example less than 10 nm, down to for example 2 nm or even 1 nm. Electrodes with a diameter that small are advantageously better tolerated by cells, particularly biological cells. Thus, the long term stability of the electricity generation is improved. Furthermore, the resistance between each of the electrodes and the interior of the cells can be reduced. The electrodes can in particular comprise an arrangement of conductors with a diameter in the sub-pm range (so-called nanowires), which improve the collection of the voltage potential which is formed between the interiors and the external surroundings of the cells.

It is further advantageous if the free electrode surface of the electrodes, for example a tip of the electrode, has a spacing from the surface of the electrode carrier which is at least 10 nm, preferably at least 100 nm, particularly preferably at least 1 μm, such as for example 50 μm or more, up to into the mm range. This enables a secure positioning of the electrodes in the interior of the cells. Synthetic cells with a diameter up to the mm range can be securely contacted in particular.

According to the invention, two or more electrodes can be provided. According to preferred variants of the invention, e.g. at least ten, particularly at least one hundred, e.g. at least 1000, such as e.g. 10,000 or more electrodes are provided. The electrodes are preferably electrically connected to one another. The electrodes particularly preferably form a 1- or 2-dimensional array of electrode tips which project from the surface of the electrode carrier and are electrically insulated from the at least one counter electrode of opposed polarity. With the electrical connection of the electrodes in the case of the provision of a multiplicity of cells on the electrode carrier, the membrane potential can advantageously be derived at all cells at the same time.

According to a particularly preferred embodiment of the invention, the cells, particularly biological cells and/or synthetic vesicles, form a closed cell layer on the surface of the electrode carrier. The generator leads of the membrane potentials of the individual cells are connected in parallel and thus advantageously increase the output current of the generator device according to the invention. Advantageously, with a culture of biological cells on a surface of the support device of 1 cm², a total power of 7 μW can be generated. Thus, the performance is comparable with the performance of solar cells of the same area. In contrast with solar cells, which are based on the photovoltaic effect, the generator device according to the invention can be operated completely independently of light, however. It requires less room and is subject to less restrictive operating conditions than a solar cell battery.

Various variants of the use of the electric current generated according to the invention advantageously exist. According to a first variant, the electrodes and the at least one counter electrode can be adapted to be connected directly to a load circuit. A cable connection to the load circuit can be provided. The use directly has an advantageous effect on the deriving of the membrane potential and the activity of the ion pumps. According to a second variant, a connection to a rechargeable battery device can be provided. The rechargeable battery device is generally an electrical energy storage device, such as for example an electrochemical rechargeable battery or a capacitor with a predetermined capacitance, the concrete realization of which is selected in dependence on the requirements of the concrete application of the generator device. The rechargeable battery device can be charged with the electricity generated according to the invention, it having the advantage that a load circuit is not directly connected to the electrodes, but rather is decoupled from these. Thus, disruptive effects of the load circuit, such as for example rapid load changes on the at least one cell in the generator device can be prevented.

A cultivation device is provided according to a further advantageous feature of the generator device according to the invention. The cultivation device is adapted for supplying an ion-containing medium into the surroundings of the cells. The ion-containing medium is a liquid (e.g. a cultivation medium), using which the cells can be supplied and regenerated. In the case of the use of biological cells, the cultivation device comprises a reservoir for the cultivation medium, as is known from cell biology, and a supply device for supplying the cultivation medium to the cells on the cell holder. With the ion-containing medium, ions are continuously provided in the surroundings of the cells, which ions are transported under the action of the ion pumps into the interior of the cells and so establish the membrane potential.

If, according to a further advantageous feature of the invention, the cells contain at least one ion-binding substance in their interior, advantages for the lifetime or stability of the cells can result. The ion-binding substance acts as a buffer in the interior of the cell. The ions transported through the membrane into the interior are gathered by the ion-binding substance. Thus, particularly in the case of biological cells, the lifetime of the generator devices is increased. With the ion-binding substance, a poisoning of the cells is suppressed or completely prevented. The ion-binding substance (ion capturer) for example comprises ethylenediaminetetraacetic acid (EDTA), ascorbic acid (vitamin C) or glutathione.

Preferred applications of the generator device according to the invention exist in the case of the electrical supply of electrical devices with a relative low electrical power, such as body implants, for example heart pacemakers or hearing aids, it also being possible to supply devices with increased electricity consumption, such as household devices, however, due to the scalability of the generator device. For the supply of body implants, it is particularly advantageous that the generator device can be supplied directly with nutrients of the body, from which tissue adjoining an implant can be supplied in particular.

Further details and advantages of the invention are described in the following with reference to the attached drawings, which show in:

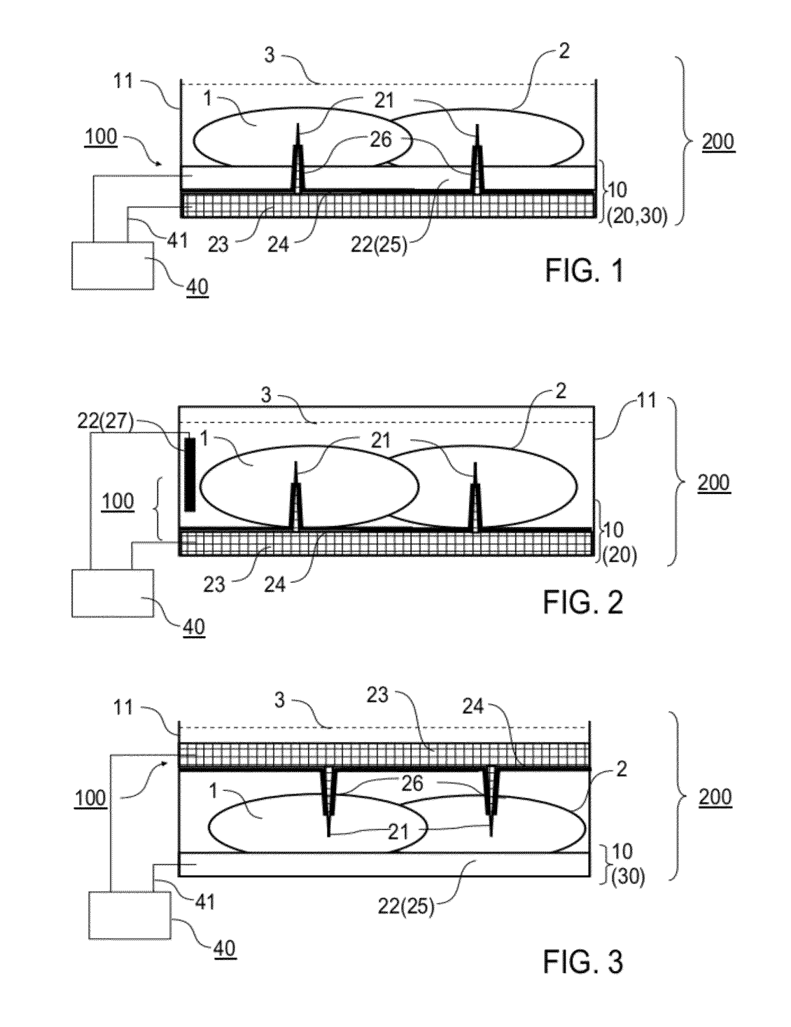

FIGS. 1 to 3: schematic, enlarged sectional views of embodiments of generator devices according to the invention;

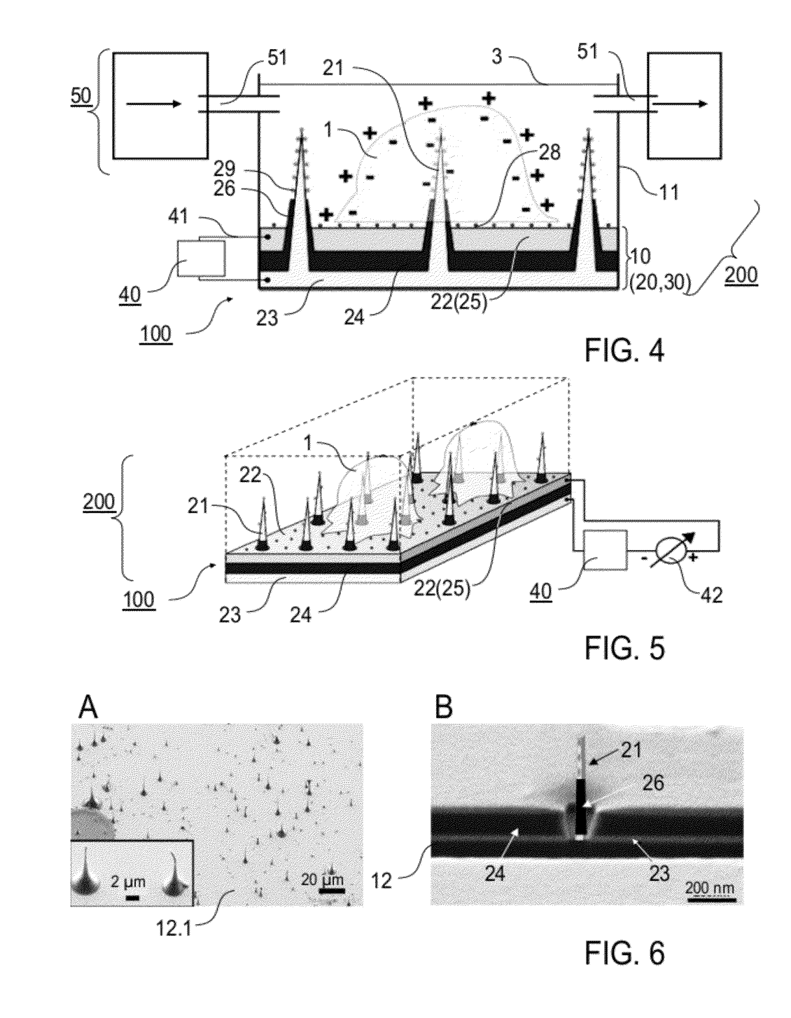

FIGS. 4 and 5: a schematic sectional view and a perspective view of a further embodiment of the generator device according to the invention;

FIG. 6A: an illustration of a structured surface which can be used as a substrate for the production of the generator device;

FIG. 6B: a photographic illustration of an electrode/counter electrode pair, for example in the case of an electrode device according to FIG. 5;

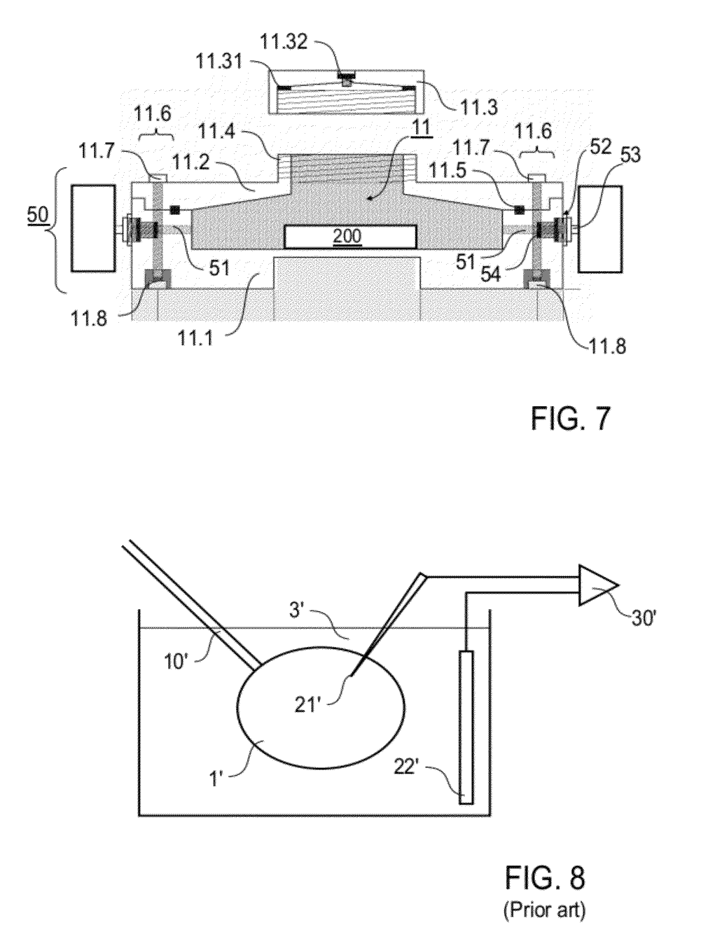

FIG. 7: a schematic sectional view of a further embodiment of the generator device according to the invention with a cultivation device; and

FIG. 8: a schematic illustration of a conventional electrophysiological measurement of the membrane potential.

Embodiments of the invention are explained in the following with reference to preferred features of the electrode device, the generator device and the method for their operation. Cell-biological and electrochemical aspects, such as for example the generation of the membrane potential, the provision of cultivation conditions for adherent cells, the integration of proteins forming ion pumps (and channels) into lipid membranes, are not described here, as they are known per se from cell biology and electrochemistry. It is emphasized that the implementation of the invention is not limited to the types of biological or synthetic cells mentioned by way of example, but rather is accordingly possible with all membrane-enclosed cells which are suitable for forming a membrane potential by means of a transporting of charged particles, particularly ions, through the membrane.

Embodiments of the invention are described with reference by way of example to electricity generation with two cells (FIGS. 1 to 3) or with more cells (FIGS. 3, 4). It is emphasized that the implementation of the invention is not limited to the described examples. The construction of the generator device according to the invention, in particular its size and the devices for supplying the cells can be selected and adapted in dependence on the actual conditions of the application of the invention.

In the following, reference is made by way of example to embodiments of the invention, in which the electrodes on the surface of the electrode carrier are cathodes and the at least one counter electrode is an anode. With this assignment of the polarities, the electricity generation takes place by means of the deriving of membrane potentials which are formed by means of the transporting of ions into and/or out of the interior of the cell. The membrane potential is e.g. formed in that a Na⁺-K⁺pump pumps only two potassium ions into the cell for three sodium ions which are pumped out of the cell. The implementation of the invention with reversed polarity is accordingly possible, in that the electrodes constitute cathodes and the at least one counter electrode constitutes an anode.

According to FIG. 1, the generator device 200 comprises an electrode device 100 with a cell holder 10 which at the same time forms the electrode carrier 20 and the counter electrode carrier 30. The electrode carrier 20 comprises cathodes 21 as electrodes and an anode 22 as counter electrode, on the surfaces of which cells 1 are arranged. The electrode device 100 is arranged with the cells 1 in a generator vessel 11 which contains an ion-containing medium 3 and can be connected to a cultivation device (not shown in FIG. 1).

The electrode carrier 20 comprises a multiple layer construction made up of a lower cathode layer 23, a middle insulating layer 24 and an upper anode layer 25, which simultaneously forms the anode 22 and the surface for accommodating the cells 1 in an adherent state. The exterior of the membrane shell 2 of the cell 1 has a direct electrical contact with the anode 23. The cathode layer 23 and the anode layer 25 are connected via electric cables 41 to a load circuit 40 and/or a rechargeable battery device (shown schematically). The production of the layer construction made up of the cathode layer 23, the insulating layer 24 and the anode layer 25 is described with further details below with reference to the FIGS. 4 and 5.

The cathodes 21 project as pointed projections from the cathode layer 23 through the anode layer 25, above the surface thereof into the generator vessel 11. For the electrical insulation of the cathodes 21 relative to the anode 23, the insulating layer 24 forms an insulating shell 26, which surrounds the cathode 21, on every cathode 21. The insulating shell 26 extends in the longitudinal direction of the cathode 21 with a length which is at least equal to the thickness of the anode layer 25. Preferably, the insulating shell 26 extends, as shown in FIG. 1, above the surface of the anode layer 25 into the generator vessel 11, in order to improve the electrical insulation of the cathode 21 and the anode 22. The axial length of the insulating shell 26 is selected in such a manner that a free end of the cathode 21 (cathode tip) is exposed in the generator vessel 11.

Generally, the cathodes 21 preferably comprise carbon, an inert metal, such as e.g. gold, or a doped semiconductor. The insulating layer 24 is formed by a ceramic layer, such as for example a metal oxide. The anode 22 likewise preferably consists of carbon, an inert metal or a doped semiconductor.

The cells 1 with the membrane shells 2 are arranged on the surface of the anode layer 25 in such a manner that the cathodes 21 project with the insulating shell 26 into the interior of the cells 1. Each cathode tip is in direct electrical contact with the inner cell material, such as for example with the cell plasma in the case of a biological cell or with an inner medium of a vesicle in the case of a synthetic cell. The cells 1 comprise for example living biological cells, such as for example epithelial cells or fibroblasts. The ion-containing medium 3 in the generator vessel 11 comprises a cultivation medium, such as for example a physiological salt solution, from which the ions are transported through the membrane shells 2 into the interior of the cells 1. The membrane potential formed in the process is derived via the electric cables 41. As soon as the ion pumps in the membrane shells 2 detect a charge balance between the interior of the cells 1 and the external medium, further ion transport into the interior of the cells 1 takes place.

Biological cells which can be used for electricity generation for example comprise cardiac myocytes (HL1), epithelial cells or fibroblasts (e.g. REF-52). Fibroblasts have the particular advantage that they form stable, long-lasting and self repairing closed monolayers on solid surfaces, particularly on the surface of the anode layer 25 or an insulating layer 24 (see below).

Advantageously, NRK cells (“normal rat kidney” cells, particularly NRK fibroblasts) can be used as biological cells. NRK fibroblasts are described for example in the publication of J. J. Torres in “Am. J. Physiol. Cell Physiol.” (Vol. 287, 2004, pp. C851-C865). NRK cells form stable monolayers, the individual cells being connected via membrane channels (so-called “gap junctions”) (see FIG. 1C of the publication mentioned). The membrane channels ensure an efficient electrical connection of the cells and thus a clear increase of the capacity of the generator device according to the invention, particularly as a function of the electrode density. In the case of simultaneous reduction of the electrode density, which can lead to a higher survival rate of the cells, capacities which are just as high or even increased capacities are realized, as cells not punctured directly are also coupled to the system.

The biological cells can be manipulated using biomolecular methods which are known per se, in order for example to form stable cell clones which stand out due to an overexpression of certain ion channels and pumps, in order to increase the electrical performance. For example, by means of the overexpression of connexin molecules (components of the above-mentioned gap junction channels)—analogously to the expression of ion channels/pumps with respect to the membrane potential—the electric coupling/capacitance in any desired cells or also vesicles can be artificially increased.

Synthetic vesicles with single or multiple-layer membrane shells can be produced with standard technologies which are known per se (see for example A. Moscho et al. in “Proc. Natl. Acad. Sci.”, Vol. 93, 1996, pp. 11443-11447). Vesicles with a diameter e.g. in the range of 1 μm to 50 μm or above 50 μm can be provided (so-called giant vesicles). The self integration of the cells on the electrode device is supported by means of the biofunctionalization of the electrode surfaces with an adhesion-promoting coating and/or an endocytosis-activating coating.

A modified embodiment of the generator device 200 is schematically illustrated in FIG. 2, in which the cell holder 10 or the electrode carrier 20 of the electrode device 100 only has the cathode layer 23 with the cathodes 21 and the insulating layer 24. An electrode rod 27 dipped into the medium 3 in the generator vessel 11 is provided as counter electrode (anode).

A further modified embodiment of the generator device 200 is illustrated schematically in FIG. 3, in which the cell holder 10 comprises the anode layer 25 with the anode 22, whilst the electrode carrier 20 with the cathodes 21 is arranged at a distance from the cell holder 10. The electrode carrier 20 is arranged in the medium 3 in the generator vessel 11 in such a manner that the cathodes 21 projecting away from the electrode carrier 20 towards the cell holder 10 project into the interior of the cells 1 arranged on the cell holder 10.

The electrode carrier 20 comprises the cathode layer 23 and the insulating layer 24 with the insulating shell 26 for each cathode 21. The cathodes 21 and the cathode layer 23 are electrically insulated with respect to the medium 3 in the generator vessel 11 and the anode 22 by means of the insulating layer 24 and the insulating shells 26. The anode layer 25 and the cathode layer 23 are connected via electric cables 41 to the load circuit 40 and/or the rechargeable battery device.

The embodiments of FIGS. 1 to 3 can be further modified as follows. First, more than two cathodes can be provided (see below, FIGS. 4, 5). Furthermore, the variants of the FIGS. 1 to 3 can be combined in that cathodes are integrated into two separated electrode carriers and project from two sides into the cells. The multiple layer construction made up of the cathode, insulating and anode layers can have further layers, e.g. a support layer, with which the multiple layer construction is stabilized and which is formed e.g. from plastic (see FIG. 6B).

The FIGS. 4 and 5 show a modified embodiment of the invention, in which an array of cathodes is provided, in a schematic sectional view (FIG. 4, cutaway) and in schematic perspective view (FIG. 5). This embodiment is particularly suitable for electricity generation by means of the deriving of the membrane potential at cell layers, particularly a monolayer. For reasons of clarity, only individual cells are shown in FIGS. 4 and 5 however.

In the embodiment of the FIGS. 4 and 5, the electrode carrier 20 comprises a multiple layer construction made up of the cathode layer 23, the insulating layer 24 and the anode layer 25, as explained above with reference to FIG. 1. The cathode layer 23 and the anode layer 25 are connected via electric cables 41 to the load circuit 40 and/or the rechargeable battery device. A current measuring device 42 can be provided, which is shown by way of example in FIG. 5.

The cathodes 21 project, in each case enclosed with an insulating shell 26, through the anode layer 25 into the generator vessel 11. The generator vessel 11 is filled with an ion-containing medium 3 which is supplied and drained by a cultivation device 50 (shown schematically) via liquid lines 51. The cultivation device 50 can furthermore have a temperature control device (not shown), with which the temperature of the generator device can be set e.g. to a physiological temperature of the cells.

An adhesion-promoting (and conductivity-increasing) coating 28 is provided on the surface of the anode layer 25, which coating for example comprises fibronectin, laminin, peptides, for example RDG sequences, or collagen. The exposed tips of the cathodes 21 carry an endocytosis-activating coating 29 which for example comprises molecules, using which membrane binding strengths of the cell can be changed locally, such as for example lectins or SNARE proteins (Soluble N-ethylmaleimide-sensitive factor Attachment Receptor Protein).

The size of the surface of the anode layer 25 is selected as a function of the desired power of the generator device 200 and thus of the desired number of cells 1 which contribute to electricity generation. According to the invention, the electrode device 100 can be provided for the accommodation of more than 10, 100, 1,000, 10,000 or more cells. Accordingly, the number of cathodes 21 can be 10, 100, 1,000, 10,000 or more. Particularly preferably, the area of the anode layer 25 has a size of at least 1 cm².

With a cell diameter of approximately 30 μm, as for example in the case of fibroblast cells, 100,000 cells or more and if appropriate 100,000 or more cathodes can thus be provided. Theoretical estimates result for the use of biological cells in a total power of approximately 10 μW per cm², whereby higher powers, such as for example 10 mW, can be achieved with synthetic vesicles.

The production of the electrode device 100 takes place in accordance with a method, with which electrodes with a length of several micrometers and a diameter below 100 nm can be produced. First, it is possible to produce the cathodes 21 as a top-down process by means of conventional lithography and deep reactive ion etching (DRIE) (see C. Greiner et al. in “Langmuir”, Volume 23, 2007, pp. 3495-3502). Using this method, cathode lengths of several micrometers can be achieved. In the case of the use of optical lithography, the cathode diameter is limited to a few 100 nm. Relative small structures can be created if the DRIE method is combined with electron beam structuring or nanosphere or block copolymer micelle lithography.

According to an alternative variant, the cathodes can be constructed by means of deposition technologies (bottom-up process), a vapor-liquid-solid deposition (VLS method) or a metal halide reduction (MHR method) being provided. In the latter case, metal seed crystals which form a eutectic layer on a silicon wafer, are used for the growth of silicon nanowires by means of physical vapor deposition (see L. Schubert et al. in “Applied Physics Letters”, Volume 84, 2004, pp. 4968-4970). In the second case, the cathodes can be formed using metal halides as seed crystals (see P. Yang et al. in “JACS”, Volume 129, 2007, pp. 7228-7229).

According to a further alternative, the cathodes 21 can be formed by means of carbon nanotubes which grow in a carbon-rich atmosphere from nickel- or iron-based seed crystals (see C. J. Lee et al. in “Chemical Physics Letters”, Volume 323, 2000, pp. 554-559).

The electrode device can also be produced by means of the application of a structuring method which is described in WO 2007/096082 A1. In this case, the following multiple-step method is preferably provided. In a first step, a surface of a polymer material with a regularly or irregularly distributed thread arrangement is created by means of a melting and subsequent drawing of the threads by means of a roller, as is described in WO 2007/096082 A1. This publication is hereby included into the present description by reference. In FIG. 6A, a shaped piece (die) for the production of the electrode device with a polymer surface 12.1 structured in such a manner is shown by way of example. In a further step, the structured surface 12.1 is then coated with layers made of gold and SiO₂ and/or Si₃N₄ and structured in order to form the layer and electrode structure described here. The coating comprises a physical vapor deposition for example. The thickness of the layers is selected in dependence on the actual application conditions, particularly taking account of the electrical conductivity of the gold layer and the insulation characteristics of the SiO₂- and/or Si₃N₄ layer. Subsequently, for the provision of the electrical contact between the cytoplasm of the eukaryotic cells and the conductive gold layer, the insulating SiO₂ and/or Si₃N₄ layer is removed from the electrode tips by means of wet chemical etching or reactive ion etching. Finally, for optimization of the penetration of the electrodes into the cells and their fixing and survivability, the biofunctionalization of the surface follows using technologies which are known per se.

FIG. 6B shows a photographic representation of a part of an electrode device with a single cathode 21 (marked graphically) according to the invention, which was taken with a scanning electron microscope (SEM). On a support layer 12, the layer construction comprises the cathode layer 23 and the anode layer 25, in each case made of gold, which are separated by means of the insulating layer 24 made of SiO₂. The cathodes 21 grow as nanowires through holes in the anode layer 25, the cathode layer 23 being used as seed crystal. The cathode 21 extends perpendicularly to the surface of the anode layer 25.

FIG. 7 illustrates further details of a generator vessel 11 which is provided for accommodating the generator device 200 according to the invention (illustrated schematically without electric cables) and is connected to the cultivation device 50 (illustrated schematically). The generator device 200 can be positioned in the generator vessel 11 and/or be integrated into the base of the generator vessel 11. The generator vessel 11 is formed between a lower part 11.1 and an upper part 11.2. The lower part 11.1 has a cylindrical recess, into which the generator device 200 is integrated. The upper part 11.2 has a recess which is formed conically adjacently to the lower part 11.1 and cylindrically towards the upper side of the upper part 11.2. An inclined delimitation of the generator vessel 11, which is advantageous for the drainage of air bubbles, is formed by means of the conical region. The cylindrical region forms a base for a closure 11.3 of the generator vessel 11. For this, a connecting piece 11.4 on the upper part 11.2 is provided with an external thread which interacts with an internal thread on the closure 11.3. The closure 11.3 contains a sealing ring 11.31 and a ventilation opening 11.32.

Liquid lines 51 for connecting the generator vessel 11 to the parts of the cultivation device 50 are integrated in the lower part 11.1. The liquid lines 51 have coupling regions 52 which are in each case provided with a valve 53 for setting the media inflow and a ceramic filter 54 for filtering the media inflow. The upper side of the lower part 11.1 and the lower side of the upper part 11.2 are formed with shapes which fit one another. A seal 11.5 is provided between the lower and upper parts 11.1, 11.2. The lower and upper parts 11.1, 11.2 are coupled to one another by means of a connecting device 11.6 which forms e.g. a screw or snap-latch connection. Advantageously, the connecting device 11.6 at the same time forms a guide for a stacking for a multiplicity of generator vessels 11. So, a projection 11.7 of the connecting device is provided on the upper side of the upper part 11.2 and a recess 11.8 of the connecting device 11.6 is provided on the lower side of the lower part 11.1, which projection and recess have shapes which are complementary to one another. The projection 11.7 is e.g. formed by means of the screw head of a screw connection.

Generator vessels used according to the invention can preferably be stacked. In the assembled state of a multiplicity of generator vessels 11, an upper generator vessel 11 sits on a lower generator vessel 11, so that the projections 11.7 of the lower generator vessel 11 project into the recesses 11.8 of the upper generator vessel. Alternatively to the illustration in FIG. 7, the projections 11.7 and the recesses 11.8 can be formed independently of the connecting device 11.6 on the surfaces of the upper and lower parts 11.2, 11.1.

The features disclosed in the above description, the drawings, and the claims can be of significance both individually as well as in combination for the implementation of the invention in its different embodiments.

1. An electrode device which is adapted for deriving membrane potential at cells with membrane shells, comprising:
(a) a cell holder which is adapted for fixing the cells, and
(b) an electrode carrier which has at least two electrodes of a first polarity, wherein
(c) the electrodes are formed as projections which project above a surface of the electrode carrier and are electrically insulated relative to the surface of the electrode carrier, and wherein
(d) the electrodes are arranged in such a manner that when the cell holder is provided with cells, the electrodes are positioned in the cells.

2. The electrode device according to claim 1, in which
the electrodes are formed as projections which are electrically insulated relative to the surface of the cell holder.

3. The electrode device according to claim 1, in which
each of the electrodes has an insulating shell which encloses the electrode, extends in a longitudinal direction of the electrode and leaves one end of the electrode free.

4. The electrode device according to claim 1, which comprises:
at least one counter electrode of a second opposing polarity, which is formed on the surface of the electrode carrier and/or on a counter electrode carrier which has a spacing from the electrode carrier.

5. The electrode device according to claim 1, in which
the electrode carrier has a multiple-layer construction with an electrode layer, an insulating layer and a counter electrode layer, wherein the electrodes project in an electrically insulated manner from the electrode layer through the insulating layer and the counter electrode layer above the surface of the counter electrode layer.

6. The electrode device according to claim 1, in which
the electrodes carry an endocytosis-activating coating.

7. The electrode device according to claim 1, in which the electrodes comprise at least one of:
microelectrodes having a diameter smaller than 10 μm,
microelectrodes having a tip having a spacing from the electrode carrier which is at least 10 nm, and
microelectrodes which are formed from carbon, an inert metal or a doped semiconductor.

8. The electrode device according to claim 1, in which
at least ten mutually electrically connected electrodes are provided.

9. The electrode device according to claim 1, in which
the electrodes and the at least one counter electrode are adapted to be connected to at least one of a load circuit and a rechargeable battery device.

10. The electrode device according to claim 1, wherein the cell holder is formed by the electrode carrier or the counter electrode carrier.

11. A generator device, which is adapted for generating electric current by deriving of a membrane potential at cells with a membrane shell, comprising:
(a) an electrode device according to claim 1, and
(b) the cells, which are arranged on the cell holder of the electrode device.

12. The generator device according to claim 11, in which the cells comprise biological cells or synthetic vesicles.

13. The generator device according to claim 11, in which
the cells form a closed cell layer on the cell holder.

14. The generator device according to claim 11, in which
the cells contain at least one ion-binding substance.

15. The generator device according to claim 11, which comprises at least one of:
a cultivation device which is adapted for supplying an ion-containing medium to the cells,
a load circuit, to which the electrode device is connected, and
a rechargeable battery device, to which the electrode device is connected.

16. A method for the generation of electric current by means of the deriving of a membrane potential at cells with membrane shells, with the steps:
(a) provision of a generator device according to claim 11, and
(b) deriving of an electric current from the electrode device.

17. The method according to claim 16, further comprising at least one of the following steps:
supply of an ion-containing medium to the cells, and
cultivation of the cells on the cell holder.

18. The method according to claim 16, in which
the cells comprise biological cells or synthetic vesicles which contact the electrodes independently by means of a self integration.

19. A method of using an electrode device according to claim 1 to generate electric current for at least one of a load circuit and a rechargeable battery device.

20. A method of using a generator device according to claim 11 to generate electric current for at least one of a load circuit and a rechargeable battery device.

21. The electrode device according to claim 1, in which
the at least one counter electrode carries at least one of an adhesion-promoting and a conductivity-increasing coating.

22. The electrode device according to claim 1, in which
at least a hundred mutually electrically connected electrodes are provided.
